(19) United States
(12) Patent Application Publication
(10) Pub. No.: US 2010/0164814 A1
(43) Pub. Date: Jul. 1, 2010

(54) INFORMATION PROCESSING APPARATUS

(75) Inventor: Akira Imamura, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/645,399

(22) Filed: Dec. 22, 2009

(30) Foreign Application Priority Data
Dec. 26, 2008 (JP) 2008-333069

(51) Int. Cl. H01Q 1/24

(52) U.S. Cl. 343/702

(57) ABSTRACT

According to one embodiment, an information processing apparatus includes a housing, a communication module in the housing and configured to execute close-proximity wireless transfer with an external device, and an antenna in the communication module and having directivity in a direction the antenna faces, the communication module being in the housing to freely pivot, and is configured to change the directivity of the antenna in the communication module by pivoting.

### CROSS-REFERENCE TO RELATED APPLICATIONS

This application is based upon and claims the benefit of priority from Japanese Patent Application No. 2008-333069, filed Dec. 26, 2008, the entire contents of which are incorporated herein by reference.

### BACKGROUND

1. Field

One embodiment of the present invention relates to a close-proximity wireless transfer technique and, more particularly, to an information processing apparatus which can flexibly change the directivity of an antenna in accordance with the use mode or the type of apparatus as a communication partner.

2. Description of the Related Art

In recent years, there has been proposed a technique of using close-proximity wireless transfer to transfer image data captured by, e.g., a digital camera to a personal computer or the like.

For example, Jpn. Pat. Appln. KOKAI Publication No. 2002-24774 discloses a reading apparatus using a noncontact IC card. This device has a folding structure for size reduction.

The reading apparatus described in Jpn. Pat. Appln. KOKAI Publication No. 2002-24774, however, does not consider for flexibly changing the directivity of an antenna in accordance with the use mode or the type of apparatus as a communication partner.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing the system configuration of the information processing apparatus of the embodiment;

FIG. 3 is an exemplary block diagram for explaining the functional configuration of a communication module of the information processing apparatus of the embodiment;

FIG. 4 is an exemplary view for explaining the concept of close-proximity wireless transfer of an antenna module of the information processing apparatus of the embodiment;

FIG. 5 is an exemplary view for explaining the concept of a configuration of the communication module of the information processing apparatus of the embodiment;

FIG. 6 is an exemplary sectional view for explaining the configuration of the communication module of the information processing apparatus of the embodiment;

FIG. 7 is an exemplary view for explaining the concept of another configuration of the communication module of the information processing apparatus of the embodiment; and

FIG. 8 is an exemplary sectional view for explaining the other configuration of the communication module of the information processing apparatus of the embodiment.

### DETAILED DESCRIPTION

Various embodiments according to the invention will be described hereinafter with reference to the accompanying drawings. In general, according to one embodiment of the invention, an information processing apparatus includes: a housing; a communication module in the housing and configured to execute close-proximity wireless transfer with an external device; and an antenna in the communication module and having directivity in a direction the antenna faces, the communication module being in the housing to freely pivot, and is configured to change the directivity of the antenna in the communication module by pivoting.

An embodiment of the present invention will be described below with reference to the accompanying drawings.

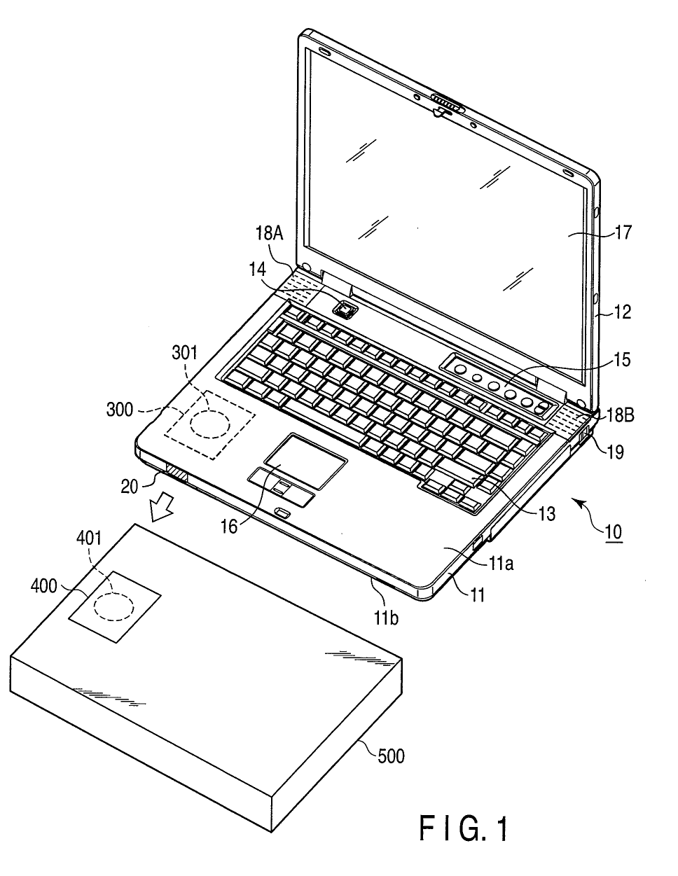

First, the arrangement of an information processing apparatus according to the embodiment of the present invention will be explained with reference to FIG. 1. The information processing apparatus of this embodiment is implemented as, e.g., a portable notebook personal computer 10.

The personal computer 10 has a function of communicating with an optional dock 500 using close-proximity wireless transfer. The optional dock 500 has various I/O ports (e.g., a USB terminal, IEEE 1394 terminal, monitor terminal, LAN terminal, PS2 terminal, sound input/output terminal). By communicating with the optional dock 500, the personal computer 10 can use an I/O port which is not included in itself. To communicate with the optional dock 500, for example, an antenna for executing close-proximity wireless transfer performs communication while pointing downward to face the optional dock 500.

The personal computer 10 can execute close-proximity wireless transfer with an external device such as a digital camera. By performing close-proximity wireless transfer, the computer 10 exchanges data with the external device. To execute close-proximity wireless transfer with the external device, the antenna for executing close-proximity wireless transfer performs communication while pointing upward to face the external device. As described above, it is possible to change the direction of close-proximity wireless transfer by flexibly changing the directivity of the antenna for executing close-proximity wireless transfer.

FIG. 1 is a perspective view showing a state in which a display unit of the computer 10 is open. When the computer 10 is placed on the optional dock 500, it can execute close-proximity wireless transfer with the optional dock 500.

The computer 10 includes a computer main body 11 and display unit 12. The display unit 12 has a built-in display device realized by a thin-film-transistor liquid crystal display (TFT-LCD) 17 (display module).

The display unit 12 is attached to the computer main body 11 to freely pivot between the open position where an upper surface 11a of the computer main body 11 is exposed and the closed position where that upper surface is covered. The computer main body 11 has a thin box-shaped housing and includes, on its upper surface, a keyboard 13, a power button 14 to power on/off the computer 10, an input operation panel 15, a touchpad 16, and loudspeakers 18A and 18B. When the computer 10 is placed on the optional dock 500, at least a lower surface 11b of the computer main body 11 is in contact with the optional dock 500. Note that in this embodiment, a direction from the lower surface 11b of the computer main body 11 to the upper surface 11a is defined as “upward”, and a direction from the upper surface 11a to the lower surface 11b is defined as “downward”. Note also that in this specification, from the viewpoint of the user opposite to the computer 10, the front side on which the touchpad 16 is arranged is defined as “front”; the rear side on which the power button 14 and input operation panel 15 are arranged, “back”; the left side, “left”; and the right side, “right”.

The input operation panel 15 is an input device for inputting an event corresponding to a pressed button, and has a plurality of buttons to activate a plurality of functions. A remote controller unit interface module 20 for implementing communication with a remote controller unit used to remotely control a TV function of this computer 10 is provided on the front face of the computer main body 11. The remote controller unit interface module 20 includes an infrared signal receiving module.

A TV antenna terminal 19 is provided on, e.g., the right side face of the computer main body 11.

A communication module 300 for executing close-proximity wireless transfer is accommodated in the computer main body 11. The communication module 300 has an antenna module 301. The communication module 300 is a communication device for performing close-proximity wireless transfer with an external device such as the optional dock 500 (to be described later) or a digital camera. The communication module 300 is arranged in the computer main body (housing) 11 to freely pivot. The communication module 300 can, therefore, change the directivity of the antenna module 301 built into the communication module 300 so as to face the external device. Note that although a case in which the antenna module 301 is built into the communication module 300 is described in this embodiment, the communication module 300 and antenna module 301 may be separately arranged and thus the antenna module 301 may be provided outside the communication module 300.

The optional dock 500 includes a dock communication module 400 for executing (two-way) close-proximity wireless transfer with the communication module 300 of the computer main body 11. The dock communication module 400 has an antenna module 401. The antenna modules 301 and 401 are antennas for executing close-proximity wireless transfer such as TransferJet, and have directivities in opposite directions. The present invention is not limited to TransferJet and any close-proximity wireless transfer technique using an antenna having directivity may be used.

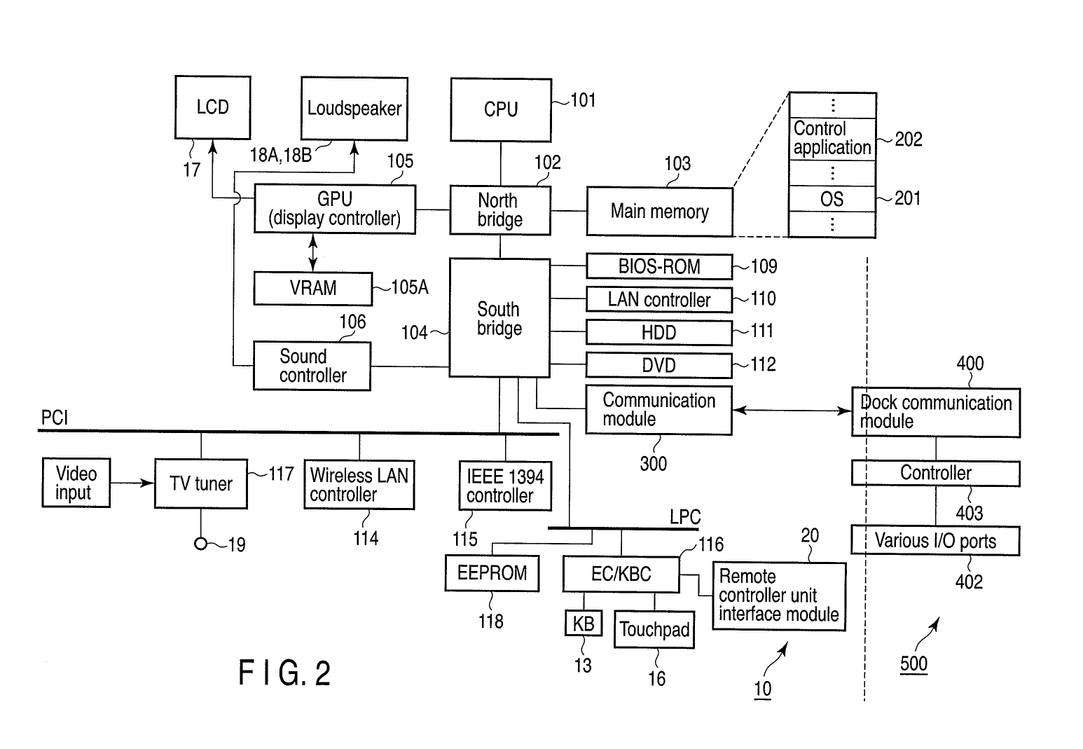

The system configuration of the computer 10 will be explained next with reference to FIG. 2.

As shown in FIG. 2, the computer 10 includes a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD [storage means]) 111, a DVD drive 112, the communication module 300, a wireless LAN controller 114, an IEEE 1394 controller 115, an embedded controller/keyboard controller IC (EC/KBC) 116, a TV tuner 117, and an EEPROM 118.

The optional dock 500 incorporates the dock communication module 400, a controller 403, and various I/O ports 402.

The CPU 101 is a processor which controls the operation of the computer 10. The CPU 101 executes an operating system (OS) 201 and various application programs such as a control application program 202, which are loaded from the hard disk drive (HDD) 111 to the main memory 103. The control application program 202 is software for controlling a close-proximity wireless transfer function.

The north bridge 102 is a bridge device which interconnects a local bus of the CPU 101 and the south bridge 104. The north bridge 102 incorporates a memory controller to make access control of the main memory 103. The north bridge 102 also has a function of communicating with the GPU 105 via, e.g., a serial bus complying with the Peripheral Component Interconnect (PCI) Express standard.

The GPU 105 is a display controller which controls the LCD 17 used as a display monitor of the computer 10. A display signal generated by the GPU 105 is sent to the LCD 17.

The south bridge 104 controls devices on a Low Pin Count (LPC) bus and those on a PCI bus. The south bridge 104 incorporates an Integrated Drive Electronics (IDE) controller for controlling the hard disk drive (HDD) 111 and the DVD drive 112. The south bridge 104 also has a function of communicating with the sound controller 106.

The sound controller 106 is a sound generator, and outputs audio data to be played back to the loudspeakers 18A and 18B.

The wireless LAN controller 114 is a wireless communication device which performs wireless communication complying with, e.g., the IEEE 802.11 standard. The IEEE 1394 controller 115 communicates with an external device via a serial bus complying with the IEEE 1394 standard.

The embedded controller/keyboard controller IC (EC/KBC) 116 is a single-chip microcomputer on which an embedded controller for power management and a keyboard controller for controlling the keyboard (KB) 13 and touchpad 16 are integrated. The embedded controller/keyboard controller IC (EC/KBC) 116 has a function of powering on/off the computer 10 in response to a user operation of the power button 14. Furthermore, the embedded controller/keyboard controller IC (EC/KBC) 116 has a function of communicating with the remote controller unit interface module 20.

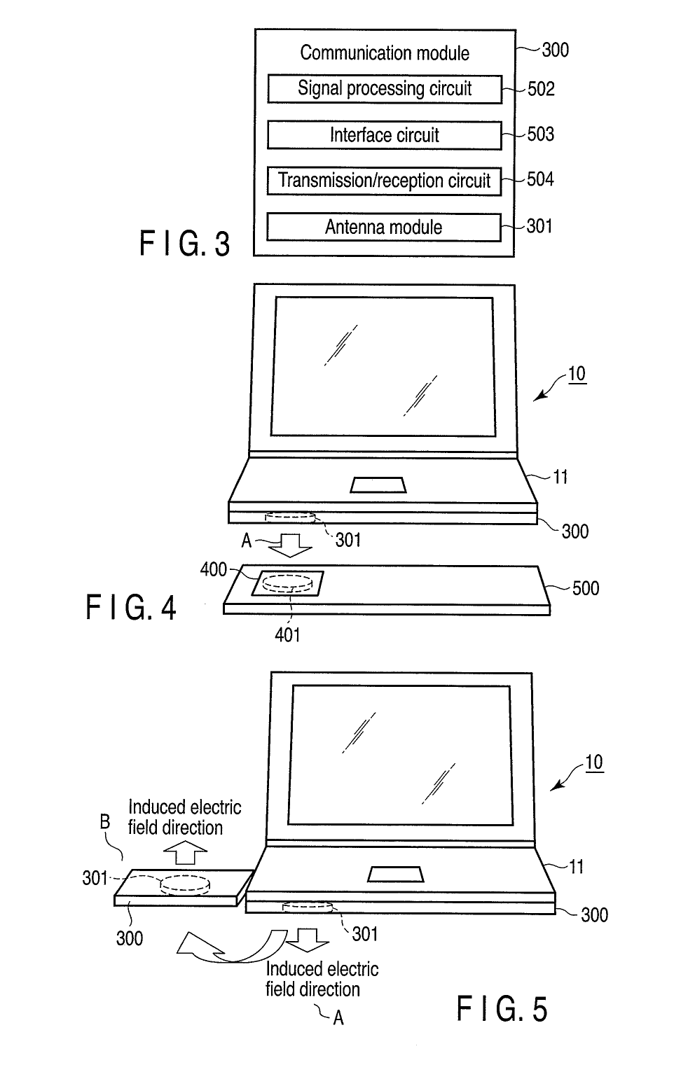

The configuration of the communication module 300 will be described next with reference to a block diagram in FIG. 3. The communication module 300 includes the antenna module 301, a signal processing circuit 502, an interface circuit 503, and a transmission/reception circuit 504. The antenna module 301 is a communication device for executing close-proximity wireless transfer having directivity in the direction it faces. The signal processing circuit 502, for example, processes data exchanged with the optional dock 500. The interface circuit 503 is an interface module for transmitting/receiving, to/from the signal processing circuit 502, data exchanged by the transmission/reception circuit 504. The transmission/reception circuit 504 is a module for exchanging data via the antenna module 301.

FIG. 4 is a view schematically showing data exchange using close-proximity wireless transfer by the antenna module (transmission coupler) 301 of the communication module 300 and the antenna module (reception coupler) 401 of the dock communication module 400. The close-proximity wireless transfer indicates communication between devices whose separation falls within the range of several centimeters to several tens of centimeters and which execute wireless communication. Although the embodiment is described below using TransferJet, the present invention is not limited to this. Any close-proximity wireless transfer technique using an antenna having directivity may be used.

For example, assume that when the optional dock 500 is placed on, e.g., a desk, the antenna module 401 built into the dock communication module 400 of the optional dock 500 stays still. In this state, the antenna module 301 built into the communication module 300 of the personal computer 10 is brought close to the antenna module 401. Upon applying an AC voltage to the antenna module (transmission coupler) 301, an induced voltage is generated vertically.

When the distance between the antenna module (transmission coupler) 301 and the antenna module (reception coupler) 401 becomes about, e.g., 3 cm, the antenna module 401 enters an induced electric field region to start data transmission.

While moving the antenna module (transmission coupler) 301 away from the antenna module (reception coupler) 401, the communication speed gradually decreases after the distance between the antenna modules exceeds about, e.g., 3 cm. When the antenna module (transmission coupler) 301 is about, e.g., 5 cm away from the antenna module (reception coupler) 401, they cannot communicate with each other.

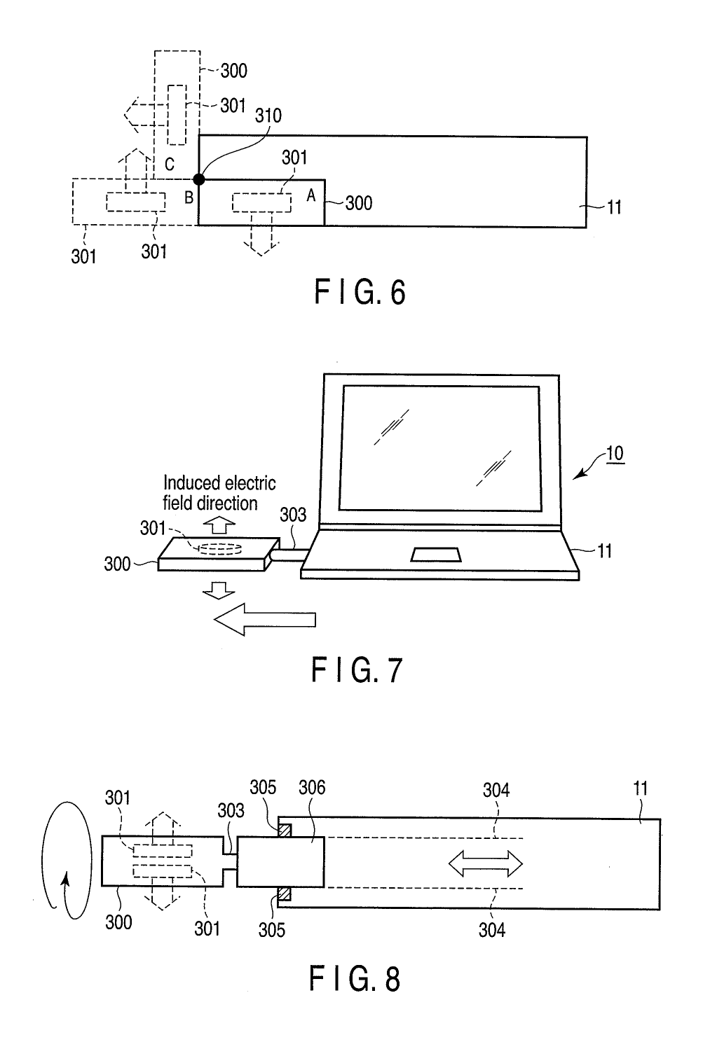

A configuration of the communication module 300 incorporating the antenna module 301 will be described next with reference to FIGS. 5 and 6.

The communication module 300 of the computer 10 is arranged in the main body (housing) 11 to freely pivot. The directivity of the antenna module 301 of the communication module 300 is changed by pivoting the communication module 300.

It is, for example, possible to assume a state (first state: state A) in which the communication module 300 is accommodated in the main body 11 and that (second state: state B) in which the communication module 300 is removed from the main body 11. The directivity of the antenna module 301 in the first state is opposite to that in the second state. Note that the antenna module 301 has a directivity pointing from the upper surface 11a of the main body 11 to the lower surface 11b in the first state while the antenna module 301 has a directivity pointing from the lower surface 11b of the main body 11 to the upper surface 11a in the second state.

FIG. 6 is a sectional view showing the above-described configuration.

The communication module 300 pivots about a hinge module 310 as part of the main body 11, and can be accommodated in the main body 11 (first state: state A). In the first state (state A), the directivity of the antenna module 301 points downward with respect to the main body 11 of the computer 10. This state is, therefore, suitable for placing the computer 10 on the optional dock 500 and then executing close-proximity wireless transfer with the antenna module 401 of the optional dock 500. In contrast, in the second state (state B), the directivity of the antenna module 301 points upward with respect to the main body 11 of the computer 10. This state is, therefore, appropriate for placing an external device such as a digital camera on the communication module 300 and then executing close-proximity wireless transfer with an antenna module of the external device. In state C, the directivity of the antenna module 301 points leftward with respect to the main body 11 of the personal computer 10. This state is, therefore, suitable for placing a large external device such as a printer to the left of the personal computer 10 and then executing close-proximity wireless transfer with an antenna module.

As an external device, a mobile phone, portable audio device, silicon disk, video camera, or the like is available. In general, a device other than the optional dock 500 is placed on or near a notebook personal computer, and the optional dock 500 is placed under the notebook personal computer. A single notebook personal computer can support these device placements (in which a device is placed on/near or under the computer). Furthermore, it is possible to support a plurality of device placements using not two coupler devices but a single coupler device by arranging the coupler device in the communication module 300 having a hinge structure. The communication module 300 can be accommodated in the housing of the notebook personal computer, thereby improving the user's usability.

As described above, in the above-mentioned embodiment, it is possible to flexibly change the directivity of an antenna having directivity so as to face a communication partner apparatus when executing close-proximity wireless transfer using the antenna. It is also possible to improve the wave characteristics without unwanted electromagnetic interference from the computer 10 by moving the communication module 300 away from the main body 11 of the computer 10.

In a modification example of the present invention, for example, as shown in FIG. 7, it is possible to pull the communication module 300 accommodated in the main body 11 and use it.

The communication module 300 incorporates the antenna module 301, and freely pivots about an axis 303. When the communication module 300 pivots, the directivity of the antenna module 301 can change, as in the above-described embodiment. Assume that the directivity of the antenna module 301 points downward with respect to the main body 11 of the computer 10. This state is suitable for, for example, executing close-proximity wireless transfer with the antenna module 401 of the optional dock 500. Alternatively, assume that the directivity of the antenna module 301 points upward with respect to the main body 11 of the computer 10. This state is suitable for, for example, executing close-proximity wireless transfer with an antenna module of an external device such as a digital camera. It is also possible to communicate with a large device by pointing the directivity of the antenna module 301 horizontally. It is thus possible to freely change the directivity of the antenna module 301.

FIG. 8 is a sectional view showing the configuration of FIG. 7.

The main body 11 of the computer 10 incorporates a rail module 304 to pull the antenna module 301. The antenna module 301 moves along the rail module 304 to be pulled from the main body 11. The antenna module 301 also has a connection module 306 and stop module 305 via the axis 303. The connection module 306 is a housing for moving along the rail module 304. The stop module 305 plays the role of a stop to prevent the connection module 306 from dropping out of the main body 11. As explained above, the antenna module 301 can pivot to change the directivity through 360°.

The present invention has been made in consideration of such situation, and has as its object to provide an information processing apparatus which can flexibly change the directivity of an antenna having directivity so as to face a communication partner apparatus when executing close-proximity wireless transfer using the antenna.

According to the present invention, it is possible to flexibly change the directivity of an antenna having directivity so as to face a communication partner apparatus when executing close-proximity wireless transfer using the antenna.

According to the above-described modification example of the embodiment, it is possible to obtain the same effects as in the above-mentioned embodiment. The above-described modules can be accomplished as software or hardware.

The present invention is not exactly limited to the above embodiments, and constituent elements can be modified and implemented upon practice without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a housing;
a communication module in the housing and configured to execute close-proximity wireless transfer with an external device; and
an antenna in the communication module and comprising directivity in a direction the antenna faces, the communication module being in the housing to freely pivot, and is configured to change the directivity of the antenna in the communication module by pivoting.

2. The apparatus of claim 1, wherein the communication module is configured to pivot with respect to the housing in order to switch to a first state or a second state, and the directivity of the antenna in the first state is opposite to the directivity of the antenna in the second state.

3. The apparatus of claim 2, the communication module is configured to pivot around a portion of the housing and is stored in the housing.

4. The apparatus of claim 2, wherein the communication module is configured to be pulled from the housing from the state in which the communication module is stored in the housing.

5. The apparatus of claim 2 wherein the communication module is parallel to the housing in the first and second states.
